(19) United States
(12) Patent Application Publication
(10) Pub. No.: US 2012/0252501 A1
(43) Pub. Date: Oct. 4, 2012

(54) System and Method for Asset Tracking Using Hybrid WAN/PAN Wireless Technologies

(76) Inventors: Jeffrey O. Smith, Dallas, TX (US); Stephen P. Emmons, Carrollton, TX (US); Andrew N. Wolverton, Plano, TX (US); Wayne Stargardt, Dallas, TX (US)

(21) Appl. No.: 13/435,253

(22) Filed: Mar. 30, 2012

Related U.S. Application Data
(60) Provisional application No. 61/470,319, filed on Mar. 31, 2011.

(51) Int. Cl. H04W 24/00; H04W 88/06; H04W 52/02

(52) U.S. Cl. 455/456.5

(57) ABSTRACT

A system for tracking mobile assets is described. The system includes a plurality of mobile asset tracking devices, where each of the tracking devices has a short range radio transmitter used to transmit identifying information to other nearby tracking devices. A subset of the plurality of mobile asset tracking devices also include location determination modules and wide area network communications transmitters, this subset of mobile asset tracking devices is operable to collect the identifying information of the nearby tracking devices without the wide area network communication transmitter and to transmit the location and identifying information of the nearby tracking devices to a monitoring center to track the plurality of mobile asset tracking devices.

### CROSS REFERENCE TO RELATED INFORMATION

This application claims the benefit of U.S. Provisional Patent Application Ser. No. 61/470,319, filed Mar. 31, 2011.

### TECHNICAL FIELD

The present disclosure is directed to the tracking of large numbers of distributed items, and more particularly to distributed items that tend to travel in large groups.

### BACKGROUND OF THE INVENTION

Battery-powered wireless asset tagging technologies for tracking mobile assets usually fall into two major categories: 1) wide area network technologies (WAN) and 2) short range wireless technologies. The WAN technologies are often based on satellite or cellular communications or other long range communication techniques. As satellite and cellular transceivers are expensive to build and operate they are usually used only for tracking larger and more valuable individual assets (such as trailers or cargo containers) over. wide geographic areas. Short range wireless technologies are used for tracking smaller or less expensive assets (e.g., personnel, mobile equipment, carts) within a small geographic area, such as a building or small campus.

WAN asset tags are usually more expensive, require much larger batteries (because they require more power and have to operate longer between battery changes/charges), and do not communicate well inside structures. Although less expensive, shorter range personal area network (PAN) technologies need to have a fixed infrastructure installed within the building/campus with which to communicate, and assets cannot be tracked when they are out of range of this infrastructure. It is also sometimes not possible to install such an infrastructure, such as when the owner of an asset (e.g., rented portable machine) is not the owner of the building in which it is used.

Neither approach cost effectively addresses the asset tracking requirements for large numbers of inexpensive items, such as leased pallets, where those relatively inexpensive assets move over large geographic areas, dwell often in buildings owned by third parties, but tend to move in groups of a dozen or more assets.

### BRIEF SUMMARY OF THE INVENTION

In preferred embodiments, a system for tracking mobile assets is described that includes a plurality of mobile asset tracking devices, each of the tracking devices having a short range radio transmitter used to transmit identifying information to other nearby tracking devices. A subset of the plurality of mobile asset tracking devices also includes location determination modules and wide area network communications transmitters so that the subset of mobile asset tracking devices with the wide area network communication transmitters can collect the identifying information of the nearby tracking devices and to transmit the location and identifying information of the nearby tracking devices to a monitoring center operable to receive the location and identifying information transmitted by the subset of mobile asset tracking devices with the wide area network communication transmitters in order to track the plurality of mobile asset tracking devices.

In other preferred embodiments, a mobile asset tracking device is described. The device includes a processor operable to control the operation of the mobile asset tracking device, and a location determination module operable to determine the location of the mobile asset tracking device. The device further includes a wide area network transmitter controlled by the processor, and a short range transceiver producing a short range radio signal controlled by the processor, the short range transceiver operable to send and receive transmissions to and from other mobile asset tracking devices within range of the short range radio signal. The mobile asset tracking device is operable to collect identifying information from one or more of the other mobile asset tracking devices and reports the location of the mobile asset tracking device and the identifying information of the other mobile asset tracking devices to a monitoring center using the wide area network transmitter.

In yet other preferred embodiments, a method for tracking a plurality of mobile assets is described that includes associating a mobile asset tracking device with each of the plurality of mobile assets, each mobile asset tracking device including a short range radio transceiver to allow communication between mobile asset tracking devices, and including a wide area network transmitter on a subset of the mobile asset tracking devices, the subset of mobile asset tracking device further including a location determination module. The method activates each of the mobile asset tracking devices according to a predetermined criteria and registers identifying information from each of the mobile asset tracking devices to one or more of the subset of mobile asset tracking devices using the short range radio transceiver so that the one or more of the subset of mobile asset tracking devices has a list of registered devices within range of the short range radio transceiver. Using the wide area network transmitter on one or more of the subset of mobile asset tracking devices the method reports the location and identification of the registered devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a system diagram of an embodiment of a system for tracking large numbers of items using both long range WAN and short range technologies;

FIG. 2 is a system diagram showing an embodiment of the system of FIG. 1 and illustrating the relationships between multiple long range WAN devices and short range devices;

FIG. 3 is a block diagram of an embodiment of a long range transceiver/controller and a short range radio or PAN device according to the concepts described herein;

FIG. 4 is a flow chart illustrating an embodiment of an operation flow for a short range radio (SRR) device; and

FIG. 5 is a flow chart illustrating an embodiment of an operation flow for a wide area network radio (WANK) device.

### DETAILED DESCRIPTION OF THE INVENTION

There is no current cost effective method for tracking relatively low value assets over wide geographic areas. Cellular-based asset tags typically cost as much as the asset being tracked, and typically more. Short range radio asset tags, on the other hand, cost ⅕ to 1/20 the cost of cellular asset tags and are more cost effective in these applications. On the other hand, short range tags cannot report asset presence outside of the range of their infrastructure (a master or coordinator PAN device), which is fixed installation and communicates back to a server. Broadly deploying the infrastructure for short range devices runs up the cost of the solution and makes it uneconomic.

Simply taking the short range radio infrastructure unit and also embedding it in an asset with a cellular radio modem is not workable. The short range infrastructure nodes are designed to be powered continuously and will not operate on battery for an acceptable time. In addition, the short range infrastructure nodes are designed to communicate verbosely with the remote server and would incur excessive cellular usage charges.

The present invention combines the strengths of the two technologies—low cost short range radios and ubiquitous and efficient reporting capability for WAN technologies—to take advantage of both and meet the application requirements for long-life battery operation, wide geographic coverage, and relatively low cost compared to asset value.

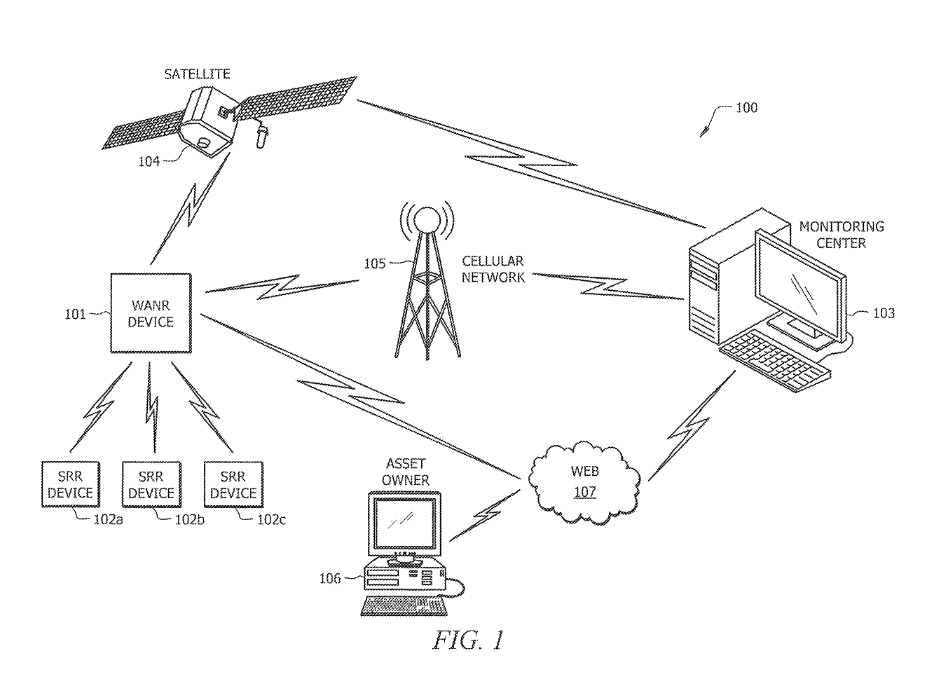

Referring now to FIG. 1, an embodiment of system 100 for asset tracking using both WAN radio devices (WANR) and short range radio devices (SRR) is shown. The system uses a combination of WANR devices 10 land SRR devices 102a, 102b, and 102c to track large numbers of mobile assets. The SRR devices 102a, 102b, and 102c detect and communicate with the WANR device 101 to register their presence within the short range radio signal of the WANR device 101. The WANR device, with its long range radio capabilities can communicate with a monitoring center 103 using a wide area network. Examples of wide area networks that can be used for long range communication include a cellular network 105, a wireless TCP/IP network 107 such as a wifi network connected to the Internet, and a satellite communications network. Any other long range network could also be used without departing from the scope of the invention.

In addition to a wide area network radio capability, the WANR device 101 can also include location determination circuitry to allow the WANR device 101 to make location determinations. The location determination circuitry can be a GPS receiver communicating with the GPS satellite network, or can be cellular network location services that use the cellular network to determination location, or can be a combination of the two networks or any other location determination system.

The monitoring center 103 receives the status updates from the WANR devices that includes all of the SRR devices that are registered with that WANR device. In this way, the monitoring center can track large numbers of mobile assets. The monitoring center can also provide access to the asset owner to log into the monitoring center system and retrieve the location of the mobile assets owned by that asset owner.

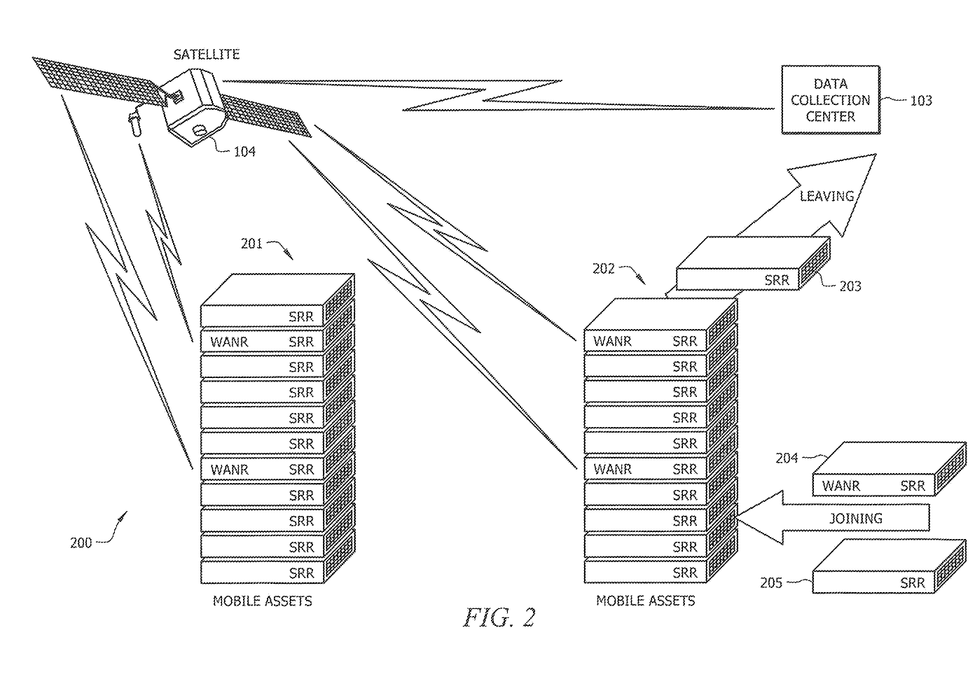

Referring now to FIG. 2, the concepts of the present invention describe a system 200 that tracks large numbers of mobile assets, such as those in groups 201 and 202, using asset tags of both types of technologies. Every asset has a short range wireless tag, SRR, such as assets 203 and 204, to communicate directly, or through network infrastructure installed at the location to communicate, with nearby like devices. Either of the direct asset-to-asset communication or use of installed local network infrastructure are considered, according to the concepts described herein, to be a PAN. A subset of the assets also have the long range, or WAN, wireless asset tag technology, WANR, in addition to the SRR tag, such as asset 205. By working together, the assets with the short range radios communicate their presence and state to one of the assets with the WAN wireless technology, which then, in turn, communicates the presence and state of all assets to a monitoring or data collection center 103 over the wide area network, shown here as a satellite network 104. Certain embodiments include a method for the asset tags to be in a “sleeping” or dormant mode most of the time in order to maximize battery life, but to become active to communicate with each other (and to synchronize time bases) at an appropriate interval or at the occurrence of a preset event or signal.

Embodiments of the system include a method whereby the reporting asset tag with the WAN capability can quickly and efficiently determine whether members of the reporting population with short range radios have changed (i.e., members have left and are no longer present; new members are joining), and can also include a method for multiple assets with the WAN technology in the same area to negotiate which one will perform the WAN reporting function so that all present assets are reported, reports are not duplicated, and the battery life of assets with WAN radios are maximized equally.

Also, in certain embodiments, assets with short range radios discover and register with the assets with WAN technology in such a way that their battery life is maximized while assuring that their presence is reported. Assets with short range radios also can determine that an asset with WAN technology is not currently present in such a way that their battery life is maximized. Where a very large number of assets (i.e., thousands, such as in a pallet depot) are present in one location, those assets can perform discovery, registration, negotiation and wide area reporting in such a way that the battery lives of all members of the population are maximized.

The WAN enabled assets can periodically, or in response to a request, transmit their location and the location of the SRR enabled assets in their presence to a data collection center. Either satellite, cellular or other appropriate technology can be used for communications between the WAN asset tag and the data collection center and those communications can be direct or through third party provider networks.

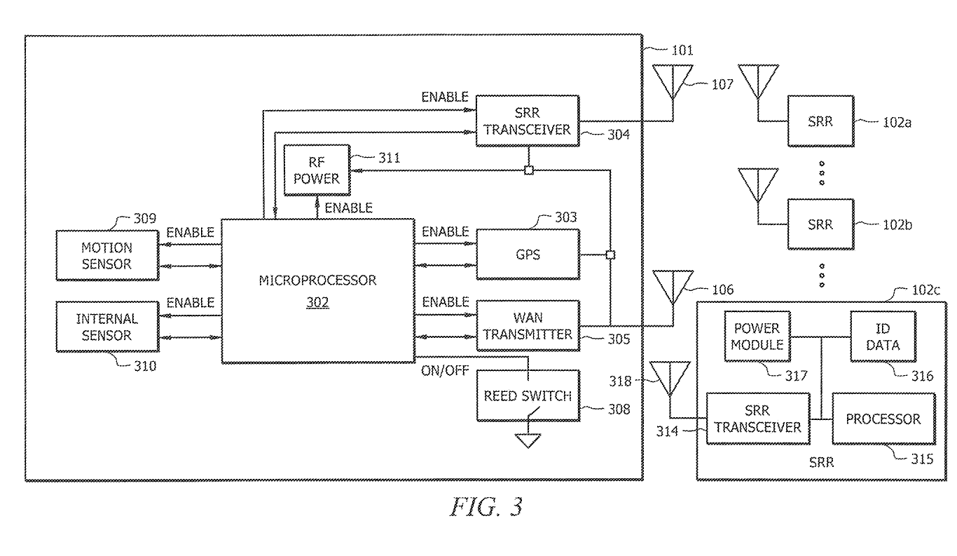

Referring now to FIG. 3 an embodiment of a WAN asset tag 101 is described. The WAN asset tag 101 includes a microprocessor 302 programmable to execute desired instructions and to keep track of nearby SRR tagged assets 102a, 102b and 102c. The processor 302 may have internal memory capable of storing data and programming information or may use memory external to the microprocessor. The WAN asset tag 101 also includes an SRR receiver 304 or transceiver used to communicate with SRR asset tags. Any type of known short range network, radio or RF signal may be used to communicate between SRR assets. The WAN asset tag 101 also includes a location determination device 303, which can be GPS or cellular based, and a WAN transmitter, receiver or transceiver 305 to communicate with the data collection center or monitoring center 103.

As described, this communication can be done using satellite, cellular or other long range communication system. Sensors 309, 310 can be embedded in or connected to the device to detect motion or other environmental information. Such information can be used to trigger communications or communications with the SRR assets and with the WAN network can be periodic or in response to a particular signal. Antennas 106 and 107 are connected to SRR receiver 304, WAN transceiver 305, and GPS unit 303 to allow those units to broadcast the appropriate signals. RFF Power module 311 provides power to the transceivers and antennas to allow their operation.

SRR assets 102a, 102b, and 102c also include an SRR transceiver 314 connected to an antenna 318. Processor 315 controls the operation of the SRR asset. AID data memory 316 in the SRR asset or processor 315 store asset information that can be broadcast to the WAN device to register the SRR assets location. Power module 318 provides power to the SRR asset as described.

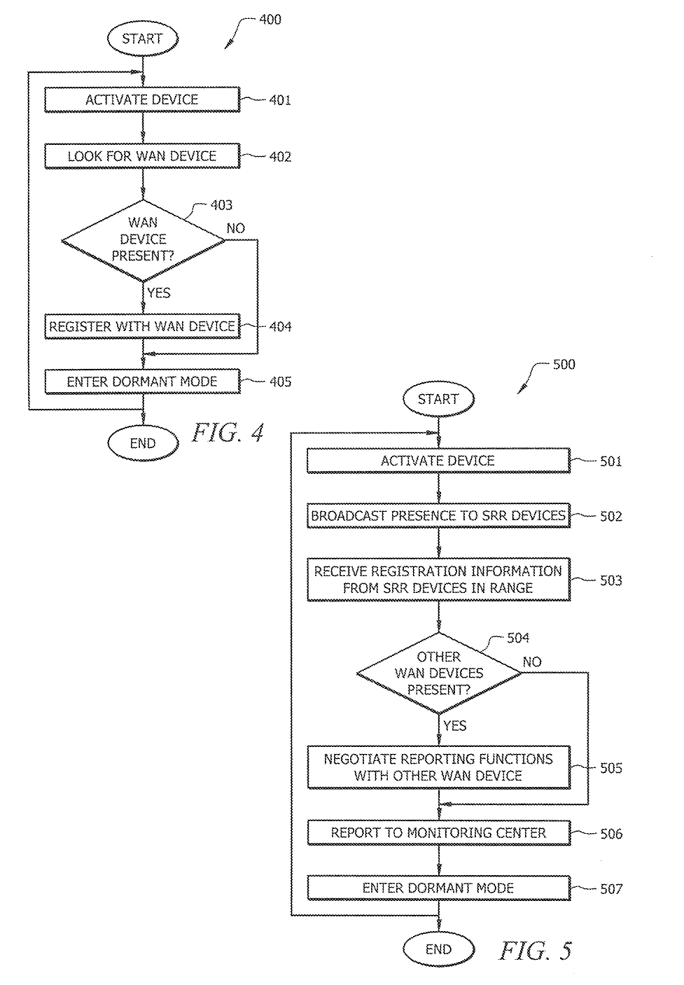

Referring now to FIG. 4 an embodiment of the operational flow for an SRR asset is described. Process 400 begins with the activation of the device from its sleep, or dormant mode as shown by block 401. As described above, the activation can occur at a specified interval, as a result of some external occurrence, in response to a signal from another device, or in response to any other circumstance or event. Once activated the SRR, as shown by block 402, the device looks for a WANR device within its radio range. The SRR asset requires a WANR device within radio range to register with so that its location can be reported to the monitoring center. In block 403, the determination is made whether a WANR device is within range. If there is not one within range the process proceeds to block 405, where the SRR asset reenters its dormant mode to conserve battery resources. If there is a WANR within range, the SRR asset registers with the WANR device, as shown by block 404, providing sufficient information to uniquely identify the SRR asset. The device then reenters its dormant mode, as shown by block 405.

Referring now to FIG. 5, an embodiment of an operational flow for a wide area network asset is described. As with the SRR device operation, process 500 begins with activating the WANR device from its sleep mode, as shown by block 501, the activation can include using the location determination device in the WANR to determine the WANR devices location. Once activated, the WANR device broadcasts its presence using its short range radio transmitter to all SRR devices in range, as shown by block 502. In response, those SRR devices send their registration information to the WANR device which receives the registration information in block 503. In block 504, the WANR device determines whether there are other WANR devices within range of its short range radio signal.

If there are not other WANR devices in the vicinity, the WANR device proceeds to report its location to the monitoring center along with the identity of all SRR devices that registered during the registration process, as shown by block 506. If there are other WANR devices present, as determined by decision block 504, the process proceeds to block 505 where the reporting functions are negotiated between the WANR devices. Once the reporting has been negotiated, the WANR device may report its location, along with the registered SRR devices, if such reporting is required by the outcome of the negotiating process in block 505. Once the reporting is done the device reenters sleep, or dormant mode, as shown by block 507.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for tracking mobile assets, the system comprising:
a plurality of mobile asset tracking devices, each of the tracking devices having a short range radio transmitter used to transmit identifying information to other nearby tracking devices;
wherein a subset of the plurality of mobile asset tracking devices also include location determination modules and wide area network communications transmitters; and wherein the subset of mobile asset tracking devices with the wide area network communication transmitters collecting the identifying information of the nearby tracking devices and to transmit the location and identifying information of the nearby tracking devices; and
a monitoring center operable to receive the location and identifying information transmitted by the subset of mobile asset tracking devices with the wide area network communication transmitters in order to track the plurality of mobile asset tracking devices.

2. The system of claim 1 wherein the wide area network communication transmitter is a cellular transmitter.

3. The system of claim 1 wherein the wide area network communication transmitter is a satellite transmitter.

4. The system of claim 1 wherein the wide area network communication transmitter is a wireless TCP/IP network transmitter.

5. The system of claim 1 wherein each of the mobile asset tracking devices includes a sleep mode to conserve battery charge.

6. The system of claim 1 wherein the location determination module is GPS module.

7. The system of claim 1 wherein an asset owner can retrieve asset location information from the monitoring center.

8. A mobile asset tracking device comprising:
a processor operable to control the operation of the mobile asset tracking device;
a location determination module operable to determine the location of the mobile asset tracking device:
a wide area network transmitter controlled by the processor; and
a short range transceiver producing a short range radio signal controlled by the processor, the short range transceiver operable to send and receive transmissions to and from other mobile asset tracking devices within range of the short range radio signal;
wherein the mobile asset tracking device collects identifying information from one or more of the other mobile asset tracking devices and reports the location of the mobile asset tracking device and the identifying information of the other mobile asset tracking devices to a monitoring center using the wide area network transmitter.

9. The device of claim 8 wherein the wide area network communication transmitter is a cellular transmitter.

10. The device of claim 8 wherein the wide area network communication transmitter is a satellite transmitter.

11. The device of claim 8 wherein the wide area network communication transmitter is a wireless TCP/IP network transmitter.

12. The device of claim 8 wherein each of the mobile asset tracking devices includes a sleep mode to conserve battery charge.

13. The device of claim 8 wherein the location determination module is GPS module.

14. The device of claim 8 further comprising a sensor connected to the processor to detect movement of the device.

15. A method for tracking a plurality of mobile assets comprising:
associating a mobile asset tracking device with each of the plurality of mobile assets, each mobile asset tracking device including a short range radio transceiver to allow communication between mobile asset tracking devices;
including a wide area network transmitter on a subset of the mobile asset tracking devices, the subset of mobile asset tracking device further including a location determination module;
activating each of the mobile asset tracking devices according to a predetermined criteria;
registering identifying information from each of the mobile asset tracking devices to one or more of the subset of mobile asset tracking devices using the short range radio transceiver so that the one or more of the subset of mobile asset tracking devices has a list of registered devices within range of the short range radio transceiver;
using the wide area network transmitter on one or more of the subset of mobile asset tracking devices to report the location and identification of the registered devices.

16. The method of claim 15 wherein the wide area network communication transmitter is a cellular transmitter.

17. The method of claim 15 further comprising sleeping each of the mobile asset tracking devices after each of the devices has registered with the subset of mobile asset tracking devices and the subset of mobile asset tracking devices has reported its location and registered devices.

18. The method of claim 15 wherein the location determination module is GPS module.

19. The method of claim 15 further comprising allowing an asset owner to retrieve the location information for mobile asset tracking devices associated with mobile assets owned by the asset owner.

20. The method of claim 15 wherein the location determination module is selected from: a GPS unit, and a cellular network location service.
